(19) United States
(12) Patent Application Publication
(10) Pub. No.: US 2005/0283795 A1
(43) Pub. Date: Dec. 22, 2005

(54) Broadcast monitoring system and method

(76) Inventors: Ryan Steelberg, Newport Beach, CA (US); Chad Steelberg, Newport Beach, CA (US)

Correspondence Address: Edward F. Behm, Jr., 2500 One Liberty Place, 1650 Market Street, Philadelphia, PA, 19103, US

(21) Appl. No.: 11/125,740

(22) Filed: May 10, 2005

Related U.S. Application Data
(60) Provisional application No. 60/571,668, filed on May 14, 2004.

(51) Int. Cl. H04N 7/025; H04N 7/10

(52) U.S. Cl. 725/32; 725/34; 725/35

(57) ABSTRACT

According to an aspect of the present invention, a communications environment including a local client/hub for monitoring, tracking, and reporting of unsold advertising inventory information. The unsold advertising inventory information is identified by a particular identifier (the “unsold identifier”). The local client/hub monitors unsold advertising inventory information related to the unsold identifier and forwards that unsold advertising inventory information to a data recorder. The unsold advertising inventory information includes the audio file, the radio station upon which the radio advertisement or program was broadcast, whether the advertisement or program was broadcast or not, the time and date the radio advertisement or program was broadcast, and other information. The data recorder passes the unsold advertising inventory information for each advertising and programming campaign to a web server where the unsold advertising inventory information is accessible over the Internet. In this manner, a subscriber may connect to the web server over the Internet and request a report on the broadcast of the advertising or program campaign. According to another aspect of the present invention, a communications environment includes a local client/hub for monitoring, tracking, and reporting on the verification of broadcast information in response to the delivery of radio advertising and radio programming. The advertising or programming campaign is identified by a particular audio file (the “campaign identifier”). The local client/hub monitors verification of broadcast information related to the campaign identifier and forwards that verification of broadcast information to a data recorder. The verification of broadcast information includes the audio file, the radio station upon which the radio advertisement or program was broadcast, whether the advertisement or program was broadcast or not, the time and date the radio advertisement or program was broadcast, and other information. The data recorder passes the verification of broadcast information for each advertising and programming campaign to a web server where the verification of broadcast information is accessible over the Internet. In this manner, a subscriber may connect to the web server over the Internet and request a report on the broadcast of the advertising or program campaign.

### CROSS-REFERENCE TO RELATED APPLICATIONS

This application claims priority to U.S. Patent Application Ser. No. 60/571,668, entitled “Broadcast Monitoring System and Method”, filed May 14, 2004, which application is hereby incorporated by reference herein as if set forth in the entirety.

### FIELD OF THE INVENTION

The present invention relates to broadcasting, and more particularly to the use of a communication system to generate, monitor and report broadcasts of radio advertising and radio programming across one or multiple stations.

### BACKGROUND OF THE INVENTION

Many broadcasters and advertisers struggle with managing broadcast and advertising campaigns, and try to identify which broadcasting and advertising is effective and, perhaps more importantly, which is not. For example, advertisers may spend thousand of dollars and dedicate countless hours producing advertising campaigns, and subsequently monitoring and managing those campaigns, in an attempt to capture the attention of and maximize the response from a selected or targeted audience. Advertisers try to target advertising to particular groups of consumers by tailoring the advertising campaign media, the frequency of the campaign, the nature of the advertisements, and many other variables. Advertisers may place advertisements in newspapers, magazines, trade journals, direct mailings, yellow pages, radio, and television. Unfortunately, advertisers do not presently have an accurate and timely mechanism for monitoring and tracking the delivery or broadcast of their campaigns, let alone the response to their campaigns. This problem may be exacerbated in broadcast radio, where advertisers may not receive verification of delivery or broadcast of advertising campaigns for up to weeks after the scheduled run of campaigns. An automated system that is capable of providing the advertiser with real-time, tailored and accurate reports on which radio advertising campaigns and programs are and were delivered, and on which station, and when, has thus far eluded those skilled in the art.

Attempts to identify and track where and when select radio advertising campaigns and radio broadcast programming are broadcast over the air have, to date, included using computer automated or manual listening posts deployed in geographic markets to record, log and analyze radio broadcasts over the air to identify songs, advertisements, and selected programming. Advertisers may contract with broadcast monitoring firms to receive reports on what advertising and radio programming was broadcast. Such a mechanism is error-prone, inefficient, and untimely. Marketers and advertisers, who often focus on increasing sales and driving product and service demand, do not have the time to wait for reports to be generated, particularly when, even after waiting for a report, the report may include discrepancies and errors.

Advertisers may be conducting costly advertising campaigns on a very tight schedule, and may need to act on a failed delivery or broadcast, either on a certain station or across a certain market, by finding alternative advertising opportunities. Such a method might come to be if the advertiser could verify immediately whether the campaign had been delivered. Monthly affidavits or reports are often inadequate to service the needs of advertisers. Reporting often does not capture crucial information to the advertiser, at least in that such reports generally fail to report the aggregate audience size, segmented by demographics and geography, at the time of advertising delivery. Such information is usually not available through any existing radio advertising and programming auditing or reporting services. However, such information may be valuable and crucial to an advertiser. An advertiser may prefer to identify the audience and those potential consumers who listened to the advertising, and directly compare those metrics against response and sales numbers.

An effective mechanism for an advertiser to monitor and track radio advertising delivery has, to date, eluded those skilled in the art. Accordingly, a need exists for a system and method for providing the broadcaster/advertiser with real-time, tailored and accurate reports on which broadcast and advertising campaigns and programs were delivered, including station information, such that the broadcaster/advertiser may identify the audience and those potential consumers who listened to the broadcast or advertising, and may directly compare those metrics against response and sales numbers.

Additionally, radio stations often operate with daily unsold advertising inventory, such as public service advertisements, bonus advertisements, unsold and/or remnant advertisements and preemptible advertisements, for example, resulting from market demand factors, poor ratings, station inefficiencies, trafficking logistics, programming logistics, and 3^{rd} party variables. This daily unsold advertising inventory may account, on average, for up to 30% of the advertising on a daily basis.

Specifically, a local station may load advertising orders into the traffic system and when these advertisements are scheduled against the schedule log gaps and holes may result. This may be caused by not having an advertisement to schedule during a certain time slot. Generally systems fill these gaps with public service advertisements, bonus advertisements and/or low-priority advertisements in order to fill in the schedule.

An effective mechanism to monitor and monetize unsold inventory has, to date, eluded those skilled in the art. Accordingly, a need exists for a system and method for monetizing unsold inventory using the schedule file and replace unsold inventory with paid advertising.

### BRIEF DESCRIPTION OF THE FIGURES

Understanding of the present invention will be facilitated by consideration of the following detailed description of the present invention taken in conjunction with the accompanying drawings, in which like numerals refer to like parts, and wherein:

FIG. 1 illustrates an architecture of a communication system 100 according to an aspect of the present invention;

FIG. 2 further illustrates the system of FIG. 1; and,

FIG. 3 illustrates a schematic diagram of the flow of information within the communication system of FIGS. 1 and 2.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical communication system and method of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention enables the monetizing of unsold inventory. Specifically, the present invention utilizes a schedule file to identify unsold inventory, unsold avails, and files these slots with paid advertisements.

The present invention provides a system and method for accurately and timely identifying where and when a radio advertisement or radio program is broadcast. The present invention may provide a communication environment configured to monitor, track, and report on radio verification of broadcast information related to a specific advertisement or program. This broadcast information may be transmitted via a network-accessible server and formatted for retrieval over a network. The present invention may be designed to permit a reporting-service subscriber to connect, such as via a network, to a server and request a report, which may be based on the verification of broadcast information, for a selected advertising campaign or radio program.

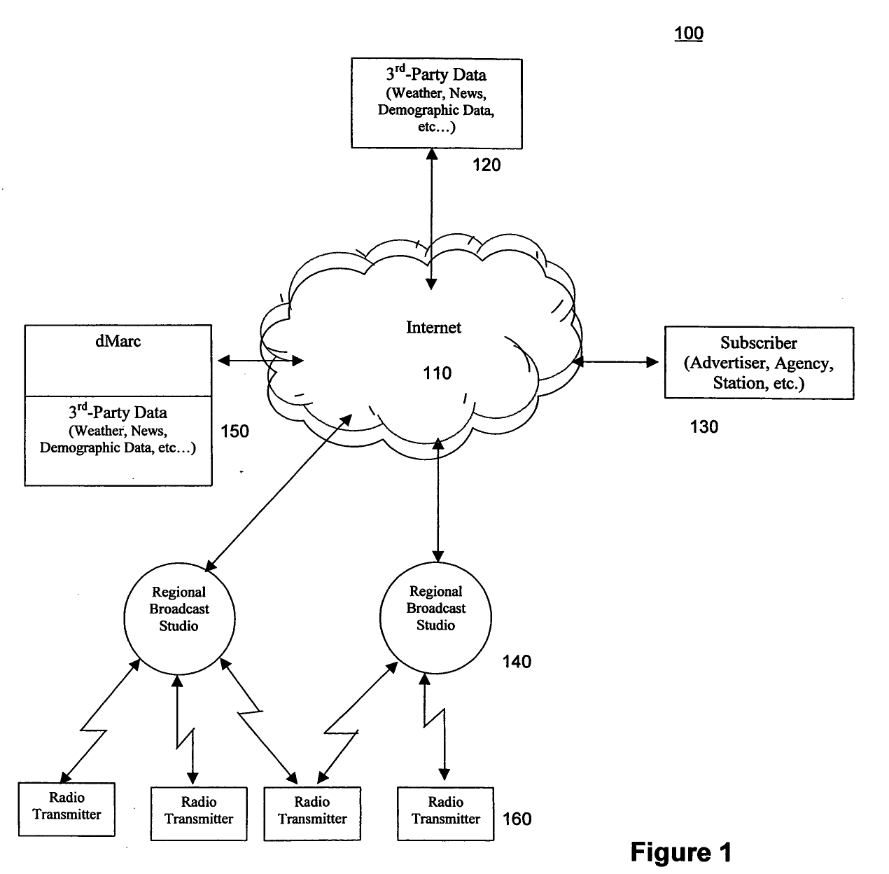

Referring now to FIG. 1, there is shown an architecture of a communication system 100 according to an aspect of the present invention. System 100 may include a networked environment 110 communicatively coupling party data 120, subscriber 130, at least one regional broadcast studio 140, and a broadcasting hub 150. At least one regional studio 140 may be further communicatively coupled to at least one radio transmitter 160.

Communication system 100 may include a broadcasting hub 150 configured to store and forward verification of broadcast information of radio advertising and radio programming from at least one regional broadcast studio 140. This verified information may be forwarded to a data recorder for recordation of a sample of the information. Further, the recorded verified information may be parsed into campaign information and remainder of the broadcast information, wherein the campaign information may include radio advertising or radio programming information associated with a broadcast event. The data recorder may make accessible the verified information to networked environment 110 such that a myriad of verified information may be accumulated as necessary. Networked environment may forward the verified information to a subscriber 130 and/or broadcasting hub 150 responsive to a request for the verified information.

According to an aspect of the present invention, the identification of when a radio advertisement or radio program was broadcast may be achieved. This identification may be performed within the broadcasting hub 150. Within hub 150 a data collector may identify verification of broadcast information related to an audio file associated with an advertising campaign or radio program, and may forward that information to networked environment 110. Hub 150 may include software for tabulating and formatting the information into a serviceable report, such as in response to a request by subscriber 130. The information in, for example, such a report, may be presented based on many different criteria, such as, for example, the total number of advertising or programming broadcasts per campaign, a listing of which stations the radio advertisement or program was broadcast over, an hourly breakdown of the broadcasts, the demographics of the broadcast audience, the geography of the broadcast audience, and/or the format of the radio stations, for example.

According to an aspect of the present invention, the reports available to subscriber 130 may reflect the latest information available. The verification of broadcast information may be forwarded from the data collector to networked environment 110, such as when the verification of broadcast information becomes available from broadcast hub 150. Such a substantially real-time report may provide subscriber 130 with substantially real-time data regarding the delivery of radio advertisements and radio programs.

According to an aspect of the present invention, the verification of broadcast information associated with advertising campaigns or programs may be combined with other information, and may be stored in additional databases either resident on or accessible by networked environment 110, to produce reports of demographic information about the audience of the advertising campaign or program. Such other information for combination with the verification information may be obtained, for example, from relevant internet or intranet sites, either automatically in response to an instruction included with the submission of the program to be broadcast, or manually upon receipt of a subscriber request.

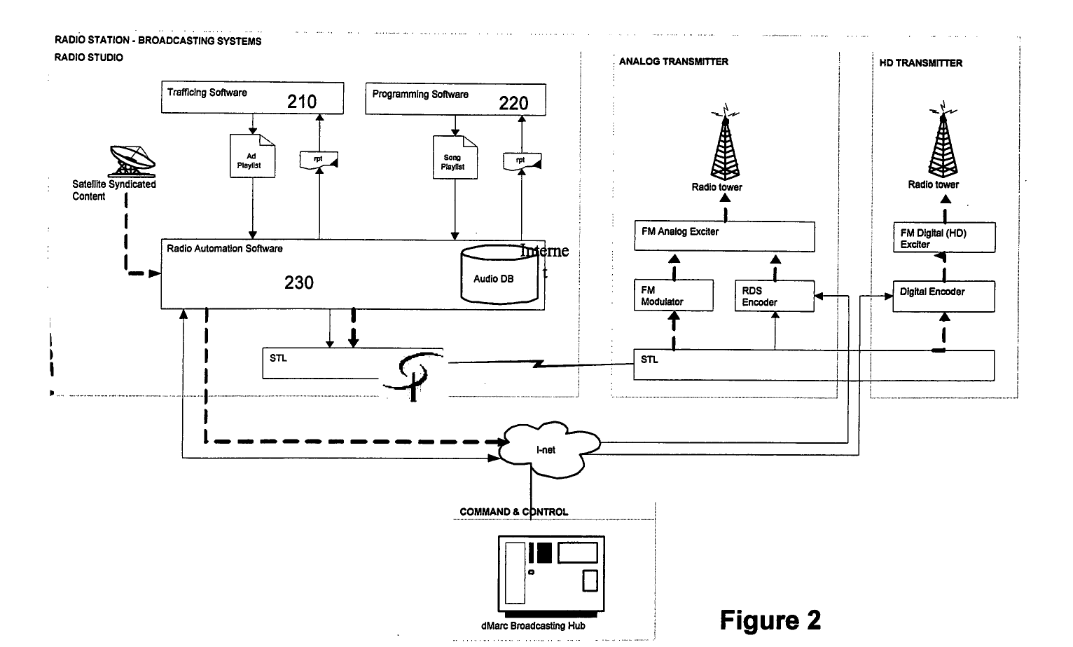

In order to more fully describe the interconnectivity, an exemplary embodiment is set forth herein below. Referring now also to FIG. 2, there is shown a system according to an aspect of the present invention. Subscriber 130 may conduct one or more broadcast or advertising campaigns by purchasing radio advertisements across several local and regional radio stations. Subscriber 130 may distribute audio commercials to the radio stations for scheduling by a regional broadcast studio 140. Subscriber 130 may verify the delivery and track the broadcast of each of the one or more advertising campaigns and associated audio commercials. It may be beneficial for subscriber 130 to engineer the one or more advertising campaigns with a unique and corresponding file name. In this regard, each audio commercial digital file may have a subscriber 130—associated, unique file name. The audio commercial digital files associated with the advertising campaigns are referred to in this discussion as “campaign creatives.”

Regional broadcast studio 140 may broadcast a campaign creative for subscriber 130. Regional broadcast studio 140 may initiate a broadcast of the campaign creative by scheduling broadcast delivery within its trafficking system 210 or programming system 220. The campaign creative may be loaded onto radio automation software 230 of station 140. Radio automation software 230 may include the scheduling and/or “flight” information as provided by trafficking system 210 and programming system 220. Broadcast hub 150 may forward scheduling information regarding the campaign creative, captured from radio automation software 230, to data collector. At the scheduled time, radio automation software 230 may stream the campaign creative to a station transmitter 160 for subsequent broadcast over the air. Broadcast hub 150 may forward verification of broadcast information regarding the campaign creative, captured from radio automation software 230, to data collector. The data collector may accumulate and/or store the information passed from broadcast hub 150.

According to an aspect of the present invention, data collector may isolate the verification of broadcast information related to campaign identifiers, for example, by including a table identifying the campaign identifiers. When verification of broadcast information arrives regarding one of the campaign identifiers in the campaign identifier table, the data collector may forward that verification of broadcast information (“campaign information”) to hub 150. The data collector may forward the campaign information as it arrives, or on a timed basis, such as in fifteen minute increments, one-hour increments, several-hour increments, or other increment known to those skilled in the pertinent arts. The rate at which the campaign information is passed from the data collector to hub 150 may limit how current, or real-time, a report may be. In this regard, the data collector according to an aspect of the present invention may be configured to provide the campaign information to hub 150 in real-time, such as not later than a few hours after the campaign information becomes available at the data collector. A portion of hub 150 may include a web server that receives the verification of broadcast information associated with each campaign identifier (the campaign information) from the data collector and stores that information on a permanent storage medium, such as a hard disk drive. The web server may tabulate the campaign information based on each campaign identifier. The table containing the campaign information may be as current as the rate at which the data collector provides the campaign information to the web server. Consequently, hub 150 via the web server may be able to generate reports of the broadcast of radio advertisements and radio programming in substantially real-time.

Hub 150 may provide access to the tabulated data over internet 110. Although internet 110 may be described as a wide area network for making the reports available to subscribers, those skilled in the art will appreciate that the system and method of the present invention encompasses any wide area network that allows access by subscribers to data stored on hub 150. Subscriber 130 may access hub 150 via a connection to internet 110. The connection to internet 110 may be any conventional connection that allows access to hub 150. For example, subscriber 130 may access hub 150 using TCP/IP and a conventional dial-up connection over a modem, or a dedicated connection that provides constant access. Hub 150 may have a unique HyperText Transfer Protocol (HTTP) address, a unique FTP address, or any other addressing scheme that allows subscriber 130 to identify hub 150.

Hub 150 may include server software, such as within a web server, that may allow subscriber 130 to request a report of a particular radio advertisement broadcast or radio program broadcast at any time. For example, subscriber 130 may connect to internet 110 in the middle of the day on a Tuesday. At that time, subscriber 130 may log on to hub 150 using a secure access protocol and issue a request to the web server to provide a report. The issued request identifies the particular radio advertisement or radio program of interest by campaign identifier. Hub 150 may respond to the request by reading the data stored in the table of campaign information associated with the campaign identifier provided by subscriber 130. Software resident on the web server may tabulate the report in accordance with the request. Finally, the web server publishes, such as in HTML or XML format, for example, the report to subscriber 130. In this manner, subscriber 130 may access and query the web server as frequently as desired to determine the broadcast of a particular advertising campaign or radio program.

Hub 150 and the web server may be configured to transmit reports to subscriber 130 at predetermined intervals, such as immediately, hourly, daily, weekly, or other time frame. For instance, software may be configured to simulate a subscriber request and cause the web server to generate and transmit the report to subscriber 130. Alternative means of delivery may also be employed, such as via electronic mail. These and other alternatives will become apparent to those skilled in the art upon a study of the disclosed embodiments.

Hub 150 and the web server may be configured to generate the report in response to a triggering event. Examples of such a triggering event may be a confirmation of broadcast for a select advertisement or program, or of a situation wherein an advertisement or program was scheduled to broadcast, but failed to deliver, or of an advertising campaign reaching a dollar cap value, for example. For instance, the web server may be configured to analyze the campaign information as it is received from the data collector. If the campaign information reflects that an advertisement with a specified campaign identifier was scheduled to broadcast at a certain time, but failed to broadcast, the web server may respond by issuing a flag to subscriber 130. According to an aspect of the present invention, the web server may be configured to extract from the campaign information the advertising client's telephone number, email, fax, or the like associated with the campaign identifier and transmit the broadcast information directly to subscriber 130 or someone associated with the subscriber, such as to follow up on the failed broadcast. The campaign information may be transmitted by digital or voice pager, by e-mail message, by human interaction, or by any other mechanism for alerting subscriber 130. In that manner, subscriber 130 may be substantially immediately notified that an advertisement failed to broadcast, and be provided with the radio station's contact information and advertising client information. Those skilled in the art will see the enormous benefits created by this aspect of the invention over existing technologies.

As may be evident to those possessing an ordinary skill in the pertinent arts, a myriad of reports may be created. By way of non-limiting example only, such reports may include campaign delivery by station, campaign delivery by market, campaign delivery by date, campaign delivery by hour, broadcast failure, and demographic reports. A campaign delivery by station report may identify upon which station a selected radio advertisement or radio program was broadcast. This report may enable subscriber 130 to verify delivery across a certain station, or within an associated geographic region. A campaign delivery by market report may identify the geographic market across which the campaign was broadcast. This report may enable subscriber 130 to verify delivery and coverage within a certain market. A campaign delivery by date report may provide subscriber 130 with per-day totals of broadcasts associated with a specified campaign. Subscriber 130 may use this type of report to easily identify those days with the heaviest advertising and programming response, such as for support planning purposes. A campaign delivery by hour report may provide subscriber 130 with per-hour totals of broadcasts associated with a specified campaign. Subscriber 130 may use this type of report to identify those day parts with the heaviest advertising and programming response for support planning purposes. A broadcast failure report may provide subscriber 130 with a listing of the campaigns that were scheduled but failed to broadcast. This information allows subscriber 130 to attempt to manage sales support, and take action to remedy failure. A demographic report may be provided. For example, the advertising campaign, broadcast across a specific market, may be mapped to area code or zip code to provide subscriber 130 with a broad overview of geographic locations of the receiving broadcast audience. Additional databases, such as those available from Census information, may be employed to generate financial, ethnic, and age-related demographic information which may be of use to subscriber 130.

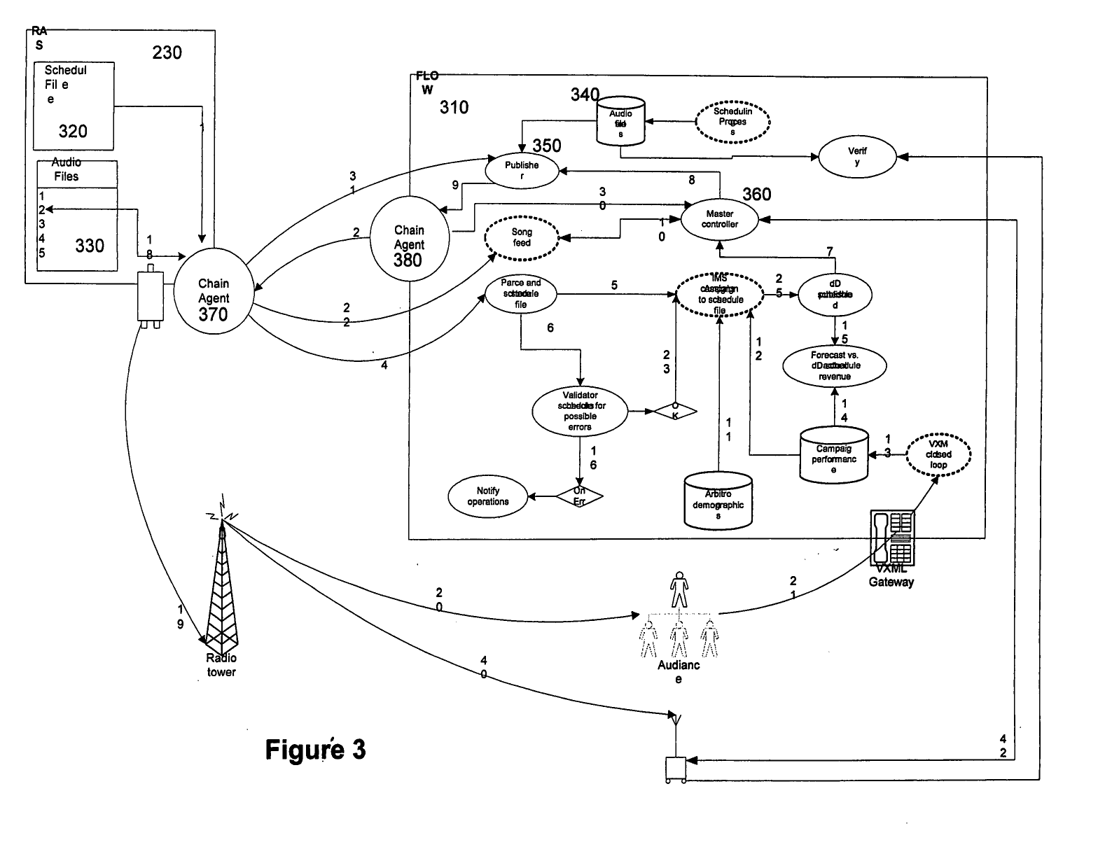

Referring now to FIG. 3, there is shown a schematic diagram of the flow of information within the communication system of FIGS. 1 and 2. FIG. 3 shows information flow 300. Information flow 300 includes two principle regions, RAS 230 and flow 310. RAS 230 may include schedule file 320 and audio file 330. Flow 310 may include audio advertisement files 340, publisher 350, and master controller 360. The flow of information will be described with reference to the numerals labeling the arrows representing the flow of information.

RAS 230 may include a flow of information for a new schedule file 1. New schedule file may originate with schedule file 320 and be transmitted to a first chain agent 370. This transmission may occur by an external software that publishes a new schedule file to the RAS 230 file system. A first chain agent 370, via a directory watcher process, detects new schedule file 320, and reads it off of disk. This new schedule file 320 may originate or be taken from several systems within the radio station and or from a location outside the studio itself (in the case of remote network programming). Eventually, schedule file 320 may be created while remaining unpublished to RAD 230. The filling algorithm may be local, and the rules for filing the inventory may not be dynamic nor take into consideration a revenue maximization function. For example, 3rd party groups today will “buy” unsold inventory in advance and give the station 1-N ads, that the station can “fill” unsold inventory. The station in this case is selling unsolds in advance without a guaranteed schedule.

First chain agent 370 residing in RAS 230 may pass information to a flow 310. This retrieval of a new schedule file 320 may be seen in FIG. 3 as link 4. This information may be passed to a parse and store step located within flow 310. As the RAS chain agent 370 reads schedule file 320, the file may be transmitted to flow 310. The dD preemptable ad avails (dD Avails) may be parsed from schedule file 320 and stored for further processing. The original schedule file 320 may be stored for billing, accounting, and auditing purposes. This parsing and storing, shown and described to occur within flow 310, may be achieved at studio 140.

After parsing and storing the schedule file, the information is transmitted to the IMS where the campaign is assigned to schedule file 320. This transmission is shown by label 5 and may occur within flow 310. This represents the delivery of the dD Avails to IMS. Rather than collecting the unsold inventory report in a central location, the central location, which tracks ad effectiveness, may publish results to each station and the local station software may use this information to make “intelligent” insertion over unsold inventory. The available ads may need to be published or delivered to station 140 and station 140 may need to receive performance data on those campaigns, so that the local engine may make decisions.

Similarly, after parsing and storing the schedule file, a validator checks for possible scheduling errors. The transmission of information to the validator is shown by label 6. The validator may input this information and analyze schedule file 320 for errors in tag structure, frequency of tags, station contractual obligations, such as minimum number of spots per period, and other errors known to those possessing an ordinary skill in the pertinent arts. This validation, while shown to occur within flow 310, may occur local to hub 150. The validator may output information to IMS on whether the schedule file 320 is validated. This validity feedback is shown by label 23. Once IMS receives an appropriate response from the validator, IMS may process the new dD Avails, by assigning dD advertisements and specific creatives to specific dB Avails. This IMS, while shown to occur within flow 310, may occur local to hub 150.

After the IMS assigns campaigns to the schedule file, the processing may be complete, and the information in the schedule transmitted to a publisher as shown by label 25. The result of the processing of dB avails is a dB Schedule, which is specific to each station. This creation, while shown to occur within flow 310, may occur local to hub 150.

After publishing the schedule, information may be transmitted to the master controller as shown by label 7. The master controller may operate as the brains behind “trafficking” the unsold spots slated for preemption within the dB schedule file. The master controller receives the song feed, including ads, as to what is being played currently on a station. The master controller uses this feed to determine where in the current schedule file a station is. The master controller manages the replacement of the ads, and the swapping back of the original ad, once the spot has run. The master controller, while shown to occur within flow 310, may occur local to hub 150.

A feedback system may be created for creating new schedules as shown by labels 8, 9, and 2. This transmission path may transfer information from the master controller to the publisher, label 8, from the publisher to the second chain agent 380, label 9, and from the second chain agent 380 to the first chain agent 370. Thus, there is a schedule for a given station, master controller instruction to pre-empt a spot, and master controller instructions to restore the preempted spot after it has played. The master controller interrogates the dB Schedule file for a given station, identifying the names of all of the creatives that are scheduled to run, and publishes these creatives to the station via the 8-9-2 pathway. The chain agent examines a cache of previously stored ads to determine that it has stored all creatives. The master controller, if it determines that a spot is ready to be pre-empted, may send a notification via the 8-9-2 pathway, to instruct the chain agent to swap creative one for creative two. The chain agent may confirm receipt of this message via the 2-30 pathway.

The chain agent may manage the physical preemption process. Instructions to preempt an ad may be delivered via path 18 to audio files 330. The chain agent may preserve the original audio file X by either renaming it or moving it to a different directory on the file system. The original file, the dD spot and the slated pre-emption may be copied into a directory of the same file name. The header information within the file, used to populate the RAS screen, may be different and reflects the actual ad that will run even though the file name is the same. The header information may identify what is written to the RAS log files for billing purposes and the station may be aware that the preemption occurred. Once this preemption has been completed or failed due to some error, status may be published via pathway (2-30). The chain agent, which may be responsible for sending the song feed, known as the log, of what is actually playing on the station, such as by pathway labeled 22, may monitor the feed to see the pre-empted spot run. Once it has run, the chain agent may swap the original ad back and notifies the master controller.

The feedback pathway labeled 2, 31 may enable the chain agent to determine if the audio file is available. The chain agent may request the publisher, via pathway 30, to send it a specific creative. The publisher responds by sending the file along with a checksum to confirm the file was not corrupted in transmission via pathway 9, 2.

The chain agent 370 may also prompt the song feed across pathway 22. The chain agent, depending on the RAS configuration, may either watch the log file on the RAS to determine what is being played over the air, or may receive a data feed from the RAS directly containing play history. The chain agent may scrub the feed and publish it to FLOW. The song feed may be exported directly over the WAN to FLOW and a local agent may not be required.

In the event that the validator determines there to be an error, information may be transmitted across pathway 16 in order for notification of an error to occur. If errors are found in the schedule file, such as a result of a contractual breach or a technical issue, a set of rules may be setup dependent upon the type or error and the station the error occurred on, to notify both systems and people that are tasked to resolve the errors.

The event ad may be played. As shown in pathways 19, 20, 21 the information derived hereinabove may be transmitted to the gateway.

The information may be transmitted to a radio tower across pathway 19. Radio tower broadcasts to an audience across channel 20. As the audience responds to the pre-empted ad, by calling a telephone number, FLOW traps the caller ID or is notified from the call center, in substantially real time, or on a daily basis, for example.

New calls may be logged, and the information may be provided to IMS across paths 13, 12. As calls are logged, the calls may be tracked against the dB schedule file. Revenues and performance metrics may be tracked given audience size, Arbitron data, and other factors. This information may be used by IMS to optimize ad targeting.

Campaign performance, in addition to being transmitted to IMS, may be transmitted across pathway 14 to a forecaster. Forecaster may compare actual performance with predicted performance and revenues. The IMS algorithms may be evaluated based upon the accuracy of the predications. Over time, the forecaster may project future revenues based on inventory flow and ad campaigns scheduled in the system. The forecaster may provide automated notification to station traffic managers that the present invention may result in income.

A verification may occur. The pathway labeled 40, 42 may demonstrate the availability of verification. The master control, in addition, may instruct the local chain agent at the station to pre-empt a spot and, responsive to the notification, may notify a digital radio that can receive the broadcast of the station to record the ad scheduled by the master controller, such as by sending a schedule or a real time notification to start/stop recording. The audio may be streamed over the WAN and recorded within the FLOW environment. Verification may occur across transmission path 41 demonstrating an ad spot recorded off the air. Once the file is recorded, it may be transmitted to FLOW to verify. The verify process may compare the audio file recorded to the audio file that was shipped to the station. If there is a match, then the ad spot may be logged as verified. If no match exists, the file may be routed to a human capable of listening to the original and the recorded file to determine if the spot matches. If no match still exists, further action may be taken. Subscriber 130 may option to listen to the recorded spots and the original in one of several verification reports. This audio may be streamed over the WAN and recorded within the FLOW environment.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A system for monitoring and reporting unsold advertising inventory information, comprising:
a local client hub for transmitting advertising inventory information, and for forwarding the advertising inventory information;
a data recorder for receiving the forwarded advertising inventory information, wherein the data recorder parses unsold station inventory information from the advertising inventory information, and makes the unsold station information available for further processing.

2. The system of claim 1, wherein the advertising inventory information includes station information.

3. The system of claim 1, wherein the unsold advertising inventory information includes format information selected as at least one of the group consisting of country, rock, pop, and jazz.

4. The system of claim 1, wherein the advertising inventory information includes an associated indicator that denotes inventory as preemptable.

5. The system of claim 1, wherein the advertising inventory information includes an indicator that denotes inventory as preemptable.

6. The system of claim 1, wherein the advertising inventory information includes an indicator that denotes unsold advertising inventory as accepting a cost-per-spot advertisement.

7. The system of claim 6, wherein the unsold advertising inventory information includes indication of the minimum cost-per-spot that the unsold advertising inventory will accept.

8. The system of claim 1, wherein the advertising inventory information includes an indicator that denotes unsold advertising inventory as accepting a direct response advertisement.

9. The system of claim 8, wherein direct response advertisement includes a cost-per-call advertisement.

10. The system of claim 8, wherein direct response advertisement includes a cost-per-inquiry advertisement.

11. The system of claim 8, wherein direct response advertisement includes a cost-per-sale advertisement.

12. The system of claim 8, wherein direct response advertisement includes a cost-per-transaction advertisement.

13. The system of claim 1, wherein the unsold advertising inventory includes radio preemptable advertisements.

14. The system of claim 1, wherein the unsold advertising inventory includes open inventory.

15. The system of claim 1, wherein the unsold advertising inventory includes non-paid advertisements.

16. The system of claim 1, wherein the unsold advertising inventory includes in-house promotional advertisements.

17. The system of claim 1, wherein the unsold advertising inventory includes public service announcements.

18. The system of claim 1, wherein the advertising inventory information includes an indication of when the unsold advertising inventory is scheduled to broadcast.

19. The system of claim 1, wherein the advertising inventory information includes an indication of when the unsold advertising inventory will expire.

20. The system of claim 1, wherein the advertising inventory information includes a duration indicating the length of the unsold advertising inventory.

21. The system of claim 1, wherein the data recorder is further configured to forward the unsold advertising inventory information to the web server upon posting of a programming schedule.

22. The system of claim 1, wherein the data recorder is further configured to forward the unsold advertising inventory information to the web server upon a fixed time schedule.

23. The system of claim 22, wherein the specified time interval is less than monthly.

24. The system of claim 1, wherein the data recorder is further configured to forward the unsold advertising inventory information to the web server upon a client or server side event.

25. The system of claim 24, wherein the specified time interval is less than daily.

26. The system of claim 1, wherein the system operates over a wide area network.

27. The system of claim 26, wherein the wide area network is the Internet.

28. The system of claim 27, wherein a web server is further configured to formulate a report based on the unsold advertising inventory information at predetermined time intervals.

29. The system of claim 28, wherein the web server is further configured to formulate a report based on the unsold advertising inventory information in response to a triggering event.

30. The system of claim 1, wherein the unsold advertising inventory information is collected from a radio station ad trafficking system.

31. The system of claim 30, wherein the radio station ad trafficking system is a Wicks Broadcasting system.

32. The system of claim 1, wherein the unsold advertising inventory information is collected from a radio station program trafficking system.

33. The system of claim 1, wherein the unsold advertising inventory information is collected from a radio station automation system.

34. The system of claim 33, wherein the radio station automation system is a Scott Studios' system.

35. The system of claim 33, wherein the radio station automation system is an ENCO system.

36. The system of claim 33, wherein the radio station automation system is a RCS system.

37. The system of claim 33, wherein the radio station automation system is a Prophet Systems system.

38. The system of claim 33, wherein the radio station automation system is an AudioVault system.

39. The system of claim 33, wherein the radio station automation system is a Broadcast Software International system.

40. The system of claim 1, wherein the unsold advertising inventory information is published by a station manually.

41. The system of claim 1, wherein the unsold advertising inventory information is published by a station automatically.

42. A method of reporting the unsold advertising inventory using a local hub, comprising:
accumulating unsold advertising inventory information associated with a radio station;
in response to a request for a report, formulating the report based on the accumulated unsold advertising inventory information for the selected radio station;
formatting the report for transmission over the Internet; and
transmitting the formatted report over the Internet to an entity or system.

43. The method of claim 42, wherein the accumulating occurs substantially continuously and the report includes the last unsold advertising inventory information accumulated.

44. The method of claim 42, wherein the formatting the report comprises converting the report to a HyperText Markup Language readable by a web browser.

45. The method of claim 42, wherein the formatting the report comprises converting the report Extensible Markup Language (XML).

46. The method of claim 42, wherein the report comprises a listing of the unsold advertising inventory that is preemptable.

47. The method of claim 42, wherein the report comprises a listing of the unsold advertising inventory that will accept a cost-per-spot advertisement.

48. The method of claim 42, wherein the unsold advertising inventory information is accumulated in a campaign database stored on a web server accessible over the Internet.

49. The method of claim 48, wherein the formulating the report comprises accessing the campaign database to retrieve the unsold advertising inventory information associated with the selected radio station or radio format and tabulating the unsold advertising inventory information in accordance with the request for the report.

50. The method of claim 42, wherein the report comprises a listing of the unsold advertising inventory that will accept a direct response advertisement.

51. The method of claim 50, wherein direct response advertisement includes a cost-per-call advertisement.

52. The method of claim 50, wherein direct response advertisement includes a cost-per-inquiry advertisement.

53. The method of claim 50, wherein direct response advertisement includes a cost-per-sale advertisement.

54. The method of claim 50, wherein direct response advertisement includes a cost-per-transaction advertisement.

55. The method of claim 42, wherein the report comprises a listing of radio stations with unsold advertising inventory.

56. The method of claim 42, wherein the unsold advertising inventory includes radio preemptable advertisements.

57. The method of claim 42, wherein the unsold advertising inventory includes open inventory.

58. The method of claim 42, wherein the unsold advertising inventory includes non-paid advertisements.

59. The method of claim 42, wherein the report comprises geographical data associated with unsold advertising inventory.

60. The method of claim 42, wherein the report comprises station format information associated with unsold advertising inventory.

61. The method of claim 42, wherein the report comprises audience demographic information associated with unsold advertising inventory.

62. The method of claim 42, wherein the report comprises time slot performance data information associated with unsold advertising inventory.

63. The method of claim 42, wherein the formatted report is transmitted over the Internet as electronic mail.

64. A method of reporting the unsold advertising inventory information of radio stations using a local hub, comprising:
monitoring unsold advertising inventory information associated with a selected radio station;
in response to the occurrence of a triggering event, generating an alert associated with the unsold advertising inventory information; and
transmitting the alert to an entity or system.

65. The method of claim 64, wherein the triggering event includes a scheduled but failed broadcast of an advertisement or program.

66. The method of claim 64, wherein the triggering event includes a successful broadcast of an advertisement or program.

67. The method of claim 64, wherein transmitting the alert comprises issuing a paging message to the entity associated with the advertising or program campaign.

68. A system for monitoring and reporting the verification of broadcast of radio advertising identified by a campaign identifier, comprising:
a local hub for transmitting verification of broadcast information of radio advertising, and verification of broadcast information to a data recorder;
the data recorder for storing the verification of broadcast information and parsing campaign information from the verification of broadcast information, the campaign information comprising radio advertising or radio programming information associated with a broadcast event to the campaign identifier, wherein the data recorder forwards the verification of broadcast information to a web server;
the web server for accumulating the verification of broadcast information and forwarding the verification of broadcast information over a wide area network in response to a request for the verification of broadcast information associated with the campaign identifier.

69. The system of claim 68, wherein the verification of broadcast information includes an audio file associated with the campaign identifier.

70. The system of claim 68, wherein the verification of broadcast information includes an advertising campaign name associated with the campaign identifier.

71. The system of claim 68, wherein the verification of broadcast information includes the scheduled time of play, the actual play time, and the duration of the advertising campaign associated with the campaign identifier.

72. The system of claim 68, wherein the verification of broadcast information is collected from a radio station automation system.

73. The system of claim 72, wherein the radio station automation system is a Scott Studios' system.

74. The system of claim 72, wherein the radio station automation system is an ENCO system.

75. The system of claim 72, wherein the radio station automation system is a RCS system.

76. The system of claim 72, wherein the radio station automation system is a Prophet Systems system.

77. The system of claim 72, wherein the radio station automation system is an AudioVault system.

78. The system of claim 72, wherein the radio station automation system is a Broadcast Software International system.

79. The system of claim 68, wherein the verification of broadcast information is collected from a radio station ad trafficking system.

80. The system of claim 79, wherein the radio station ad trafficking system is a Wicks Broadcasting system.

81. The system of claim 68, wherein the broadcast information includes information on a radio advertisement.

82. The system of claim 68, wherein the broadcast information includes information on a syndicated radio advertisement.

83. The system of claim 68, wherein the verification of broadcast information includes indication that the radio advertisement was scheduled to, but failed to broadcast.

84. The system of claim 68, wherein the transmittal of information is performed in a store and forward manner.

85. The system of claim 68, wherein the verification of broadcast information includes indication that the radio advertisement or radio program was scheduled to broadcast over the air.

86. The system of claim 68, wherein the verification of broadcast information includes an indication that the radio advertisement or radio program successfully was delivered to the transmitter for subsequent broadcast.

87. The system of claim 68, wherein the verification of broadcast information includes a date and time of day that the radio advertisement was broadcast.

88. The system of claim 68, wherein the verification of broadcast information includes a duration indicating the length of time the radio advertisement was broadcast over the air.

89. The system of claim 68, wherein the data recorder is further configured to forward the campaign information to the web server upon the completion of the radio advertisement or radio program broadcast.

90. The system of claim 68, wherein the data recorder is further configured to forward the campaign information to the web server upon the initiation of the radio advertisement or radio program broadcast.

91. The system of claim 68, wherein the data recorder is further configured to forward the campaign information to the web server at a specified time interval.

92. The system of claim 91, wherein the specified time interval is less than monthly.

93. The system of claim 92, wherein the specified time interval is less than daily.

94. The system of claim 68, wherein the web server is further configured to formulate a report based on the campaign information in response to the request for the campaign information.

95. The system of claim 94, wherein the report comprises a listing of radio advertisements that successfully were delivered to the transmitter for subsequent broadcast over the air.

96. The system of claim 94, wherein the report comprises a listing of radio advertisements that were scheduled to, but failed to be delivered to the transmitter for subsequent broadcast over the air.

97. The system of claim 68, wherein the wide area network is the Internet.

98. The system of claim 68, wherein the web server is further configured to formulate a report based on the campaign information at predetermined time intervals.

99. The system of claim 68, wherein the web server is further configured to formulate a report based on the campaign information in response to a triggering event.

100. A method of reporting the broadcast of radio advertising and radio programming using a local hub, comprising:
monitoring verification of broadcast information associated with a selected radio advertisement;
in response to the occurrence of a triggering event, generating an alert associated with the verification of broadcast information; and
transmitting the alert to an entity associated with the advertising campaign.

101. The method of claim 100, wherein the triggering event includes a scheduled but failed broadcast of an advertisement.

102. The method of claim 100, wherein the triggering event includes a successful broadcast of an advertisement.

103. The method of claim 100, wherein the triggering event includes a successful initiation of broadcast of an advertisement.

104. The method of claim 100, wherein transmitting the alert comprises issuing a paging message to the entity associated with the advertising or program campaign.
